(19) United States
(12) Patent Application Publication
(10) Pub. No.: US 2009/0101001 A1
(43) Pub. Date: Apr. 23, 2009

(54) HIGH EFFICIENCY HYDRO-MECHANICAL TRANSMISSION

(76) Inventor: ROBERT LLOYD, Menlo Park, CA (US)

Correspondence Address: ROBERT LLOYD, 223 OAK CT., MENLO PARK, CA, 94025, US

(21) Appl. No.: 12/250,481

(22) Filed: Oct. 13, 2008

Related U.S. Application Data
(60) Provisional application No. 60/980,684, filed on Oct. 17, 2007.
(60) Provisional application No. 61/025,599, filed on Feb. 1, 2008.
(60) Provisional application No. 61/029,972, filed on Feb. 20, 2008.

(51) Int. Cl. F16H 47/04; F16H 39/00; F15B 11/17

(52) U.S. Cl. 91/532; 475/73; 74/720; 60/420

(57) ABSTRACT

The present invention generally pertains to hydro-mechanical transmission using fixed displacement motors and pumps in conjunction with two or more mechanical differentials to accomplish continuously variable transfer ratio change and a means to seek the operating point of peak efficiency. In addition a hydraulic transmission is described that uses only one differential. In addition, an all-mechanical by-pass feature is included to allow the operation of road vehicles at high speed for extended periods at high efficiency. A means is described to provide for mechanical stability under all operating conditions. One intended application is a hydraulic transmission system for vehicles using hydraulic regenerative braking.

The all mechanical by-pass allows operation in an “overdrive” and “free-wheeling” mode.

### RELATED APPLICATIONS

This application relates to and claims any and all benefits of U.S. Provisional Patent Application Ser. No. 60/980,684, filed Oct. 17, 2007 entitled, “HYDRAULIC PLUG-IN HYBRID VEHICLE” and U.S. Provisional Patent Application Ser. No. 60/980,120 filed Oct. 15, 2007 entitled “HIGH EFFICIENCY HYDRO-MECHANICAL TRANSMISSION” and U.S. Provisional Patent Application Ser. No. 61/025,599 filed Feb. 1, 2008 entitled “Continuously Variable Hydraulic Transmission With Efficiency Control” and U.S. Provisional Patent Application Ser. No. 61/029,972 filed Feb. 20, 2008 entitled “Continuously Variable Hydraulic Transmission With Efficiency Control”. Provisional Patent Application Ser. Nos. 60/980,684, 60/980,120, 61/025,599, and 61/029,972 are incorporated in their entirety into this application by reference.

### BACKGROUND OF THE INVENTION

1. Field of Invention

The present invention generally relates to hydraulic-mechanical transmissions for vehicles and especially those using hydraulic regenerative braking systems, and a technique for keeping such transmissions stable.

2. Description of the Prior Art

The conventional approach for changing the transfer ratio of a hydraulic transmission is to have a pump drive a motor one or both having a variable displacement. Varying either or both displacements changes the transfer ratio of the transmission. The two most common variable displacement hydraulic pumps and motors are referred to as “bent axis” and “swash plate” designs. Both of these consist of a circular array of pistons to accomplish the pumping or motor functions with a means to adjust the strokes of the pistons to accomplish a change in displacement. As a consequence, they are bulky, noisy and expensive. Further when set for low displacement they are inefficient. In addition, since the torque of a hydraulic motor is determined by its displacement, the transmissions suffer from low torque capability when set for low displacement. To compensate for this problem the transmissions must be oversized to supply sufficient torque over a full operating range.

The hydraulic transmissions described above also suffer from generally low efficiency which has also contributed to their lack of acceptance in road vehicles. This is particularly problematic when driving at high speeds for long periods. The low efficiency contributes to high operating temperature of the hydraulic fluid which greatly reduces its useful life.

A paper entitled “GoldDrive—Infinitely Variable Drive Consisting of Fixed Displacement Pumps and Motors”, submitted by Nahum Goldenberg, and published as Document NO. 2000-01-2544 by the Society of Automotive Engineers in January 2000 relating to Ground Vehicles (hereinafter the “Goldenberg Publication”) describes an infinite variable, bidirectional “GoldDrive” consisting of a combination hydraulic fixed displacement pumps and motors and a differential. [See also U.S. Pat. No. 4,922,804, Goldenberg.]

In particular, as schematically illustrated in FIG. 1, the basic configuration proposed by Goldenberg includes, in combination, a mechanically driven hydraulic pump 3 that produces a hydraulic fluid flow diverted by a valve V1 such that it is shared in different proportions between two motors, 1 and 2. Motors 1 and 2 drive the “arms” of a mechanical differential in opposite directions. If the displacements and efficiencies of motors 1 and 2 are the same and the flow is equally divided between each, the output shaft of the differential will not turn. If the flow is greater to motor 2 than motor 1, the output shaft will turn at a speed proportional the difference in flow rates in the forward direction. If the flow is greater to motor 1 than motor 2, the output shaft will turn in the opposite direction again at a rate proportional to the flow difference. The result is a transmission that has an infinitely variable transfer ratio in both forward and reverse. However to achieve stable operation with this transmission, it is necessary to provide some means achieve the same torque on both sides of the differential under all conditions.

SAE Document NO. 2000-01-2544 entitled “GoldDrive—Infinitely Variable Drive Consisting of Fixed Displacement Pumps and Motors”, and U.S. Pat. No. 4,922,804, Goldenberg are each incorporated in their entirety into this application by reference.

### SUMMARY OF THE INVENTION

A first hydraulic transmission system is described that uses two sets of differentially-coupled, fixed displacement hydraulic pumps/motors arranged such that one set is used to adjust the transfer ratio and the other to adjust the operating point to the condition of maximum efficiency. A means to achieve mechanical stability under all operating conditions is disclosed. A second hydraulic transmission is described that uses a single set of differentially-coupled hydraulic devices in the manner described by Goldenberg with the addition of the scheme to achieve mechanical stability. Further a selectable, one-way clutch mechanism means applicable to both transmissions is described to provide an all-mechanically by-pass for the hydraulic transmission in a drive train allowing efficient high and low speed operation of road vehicles and both a “free-wheeling” mode and an “overdrive” mode of operation. The all-mechanical by-pass can designed to engage at low speeds when the torque demand is low an is applicable to all hydraulic transmissions for vehicles. A particular advantage of the described hydraulic transmissions system relates to their small physical size. These transmissions can also supply all the functions necessary for vehicles using hydraulic regenerative braking systems.

In particular, a hydraulic transmission system combination is described that includes two sets of differentially-coupled, fixed-displacement pumps/motors of a type described in the “Goldenberg Publication” and U.S. Pat. No. 4,922,804, wherein a mechanically driven, input set of differentially-coupled, fixed-displacement pumps/motors provides hydraulic output via a first and second serial pair of diverter valves to a hydraulically driven, output set of differentially-coupled, fixed-displacement pumps/motors where the first diverter valve controls hydraulic output of the mechanically driven input set of differentially-coupled, fixed-displacement pumps/motors for establishing operating point control of the system, and the second diverter valve controls the speed and direction of the rotatable, mechanical output shaft of the hydraulically driven, output set of differentially-coupled, fixed-displacement pumps/motors.

More generally, the described transmission system contemplates replacing the input pump/motor 3 of the Goldenberg combination shown in FIG. 1 with two pump/motors connected to a differential in a similar fashion to the output pump/motors to afford means for adjusting the operating point of the transmission system for peak efficiency at particular operating parameters.

A particularly novel aspect of the described hydraulic transmission system relates to stabilization of Goldenberg combination of differentially-coupled, fixed-displacement pumps/motors by sensing differences in torque between the respective sides or arms of the mechanical differential utilizing wireless strain gauges sensing torque experienced by the respective shaft arms, and generating a signal proportional to the magnitude and sign of the difference in torque and applying it to control variable fluid flow valves for decreasing hydraulic liquid pressure applied across the appropriate pump/motors on one or the other sides of the mechanical differential for equalizing the torque in the respective arms for operationally stabilizing the system.

Another embodiment of the described hydraulic transmission system may include two pump/motors in place of each pump/motor of the Goldenberg combination of differentially-coupled, fixed-displacement pumps/motors to allow the transmission system to operate at higher pressures when the two or more are serially coupled and/or to tailor the capabilities of the transmission system to particular operating parameters by disabling one or more one each side of the differential. In another consideration, smaller hydraulic pumps/motors can provide higher efficiencies and higher rotation velocity (rpm) than larger hydraulic pumps/motors. So it will often be desirable to use two or more small motors or pumps in place of one large one.

Still other embodiments of the invented hydraulic transmission system includes a remotely controllable heater/cooler for adjusting the temperature, hence viscosity of the hydraulic fluid (“a viscosity changing” device) for improving efficiency.

Another embodiment of the transmission is the combination of the torque driven stabilizing scheme and the all-mechanical by-pass to the transmission as described by Goldenberg (FIG. 1).

Another embodiment of the inventions is the application of an all mechanical by-pass enabled by a selectable, one-way clutch to all hydro-mechanical transmissions for vehicles.

### BRIEF DESCRIPTION OF THE DRAWINGS

FIG. 1 is an illustration of the prior art hydraulic transmission system described by Goldenberg in SAE Publication 2000-01-2544 and U.S. Pat. No. 4,922,804.

FIG. 2 is a curve showing how the efficiency of a typical hydraulic motor or pump changes with a change in power and rpm.

FIG. 3 is a schematic representation of the basic controls of the transfer ratio and operating point of the transmission.

FIG. 4 is a diagram of the transmission showing a mechanical by-pass.

FIG. 5 illustrates the hydraulic connections when all the power is being transmitted by the mechanical by-pass.

FIG. 6 illustrates a scheme to provide for stabile operation of the transmission

FIG. 7 illustrates one of many possible mechanical designs of the transmission containing two differentials.

FIG. 8 illustrated a mechanical design to achieve minimum cost, size and mechanical stability utilizing the configuration as disclosed by Goldenberg plus the all-mechanical by-pass.

In the following description, reference is made to hydraulic pumps and motors. The preferred embodiment of this invention would use devices that can function either as pumps or motors for flows in both directions. However it can be implemented with devices that function solely as pumps or as motors and flows in one direction only.

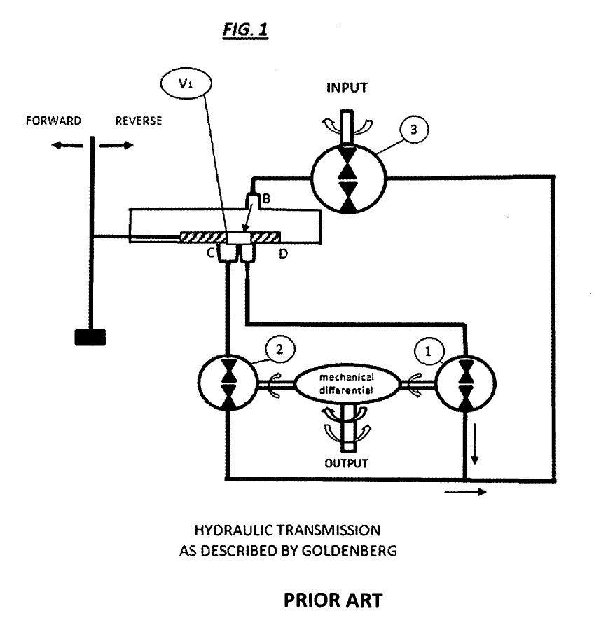

FIG. 1 describes the basic building block (prior art) of this invention. This arrangement of two hydraulic motors driving the two “arms” of a mechanical differential is as originally described in the Goldenberg Publication. The variation in transfer ratio of the transmission is achieved by changing the portion of the hydraulic flow, by means of valve V1, that drives each hydraulic motor 1 & 2. The arrangement is such that “arms” of the differential are driven in opposite directions so the output speed will be zero if equal fluid flows to each motor (and each motor has the same displacement and efficiency). As the portion of the flow is adjusted to favor one or the other motor, the output will turn in one direction or the other. The result is a continuously variable, reversible transmission. If the motors are also capable of operating as pumps, driving the output shaft will result in a continuously variable pump. This is important when the transmission is part of a hydraulic regenerative braking system. The combination of one or more hydraulic pumps or motors driving each arm of a mechanical differential with a valve arrangement to control the division of the flow between the two sets of hydraulic devices will be referred to hereafter as a “Goldenberg set” in this application.

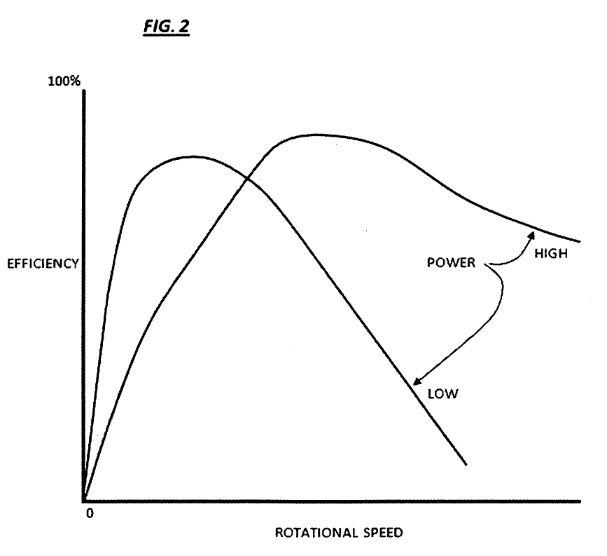

FIG. 2 shows typical curve shapes for the change of efficiency of a hydraulic motor or pump for different loads. Its significance will be apparent in the next paragraph.

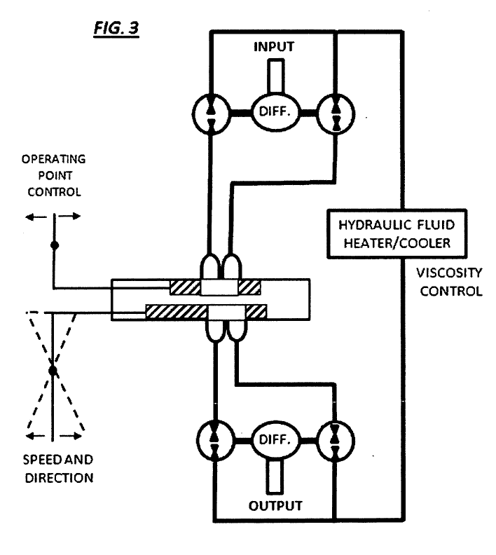

FIG. 3 describes one of the basic elements of this patent. (From here on we will assume that all hydraulic devices can function both as a pump and a motor for fluid flows in either direction. This is not a requirement of the patent, but it will simplify the controls and the discussion.) Two “Goldenberg Sets” are employed. One is used as a variable input pump and the other as the output speed control. As can be seen if FIG. 2, the efficiency at any power level can be improved it the rotational speed can be adjusted and therefore the power level of the individual devices. The purpose of the variable input pump is to allow the rotational speed of the motors and pumps to be adjusted to seek the point of peak efficiency independently of the transfer ratio. Since each motor and pump will exhibit the efficiency dependency of FIG. 2 (which will change with time), it is not practical to predict the input pumps conditions to achieve peak efficiency. It is intended that either a signal proportional to transmission efficiency or in the case of use in a vehicle, total fuel consumption per mile traveled, or some other desired result, be used to adjust the operating point as shown in FIG. 3. The feedback loop controlling the operating point would have a much slower response than that needed for the transmission's response to output speed changes. This will prevent the operating point control from interfering with the speed control of the transmission.

The range of speeds of the input pump set or the output motor set can be changed to favor one direction by changing the displacement of the pump/motor on one side of the differential and change the gearing of the differential on that side accordingly to keep the torque equal. This could be done, for example, to provide a larger speed range in the forward direction than in the reverse direction of an automobile.

FIG. 3 also illustrates the use of a hydraulic fluid cooler/heater. A change in fluid temperature also changes the efficiency due to the change in viscosity. This feature allows the temperature to be adjusted dynamically for peak efficiency at different operating conditions.

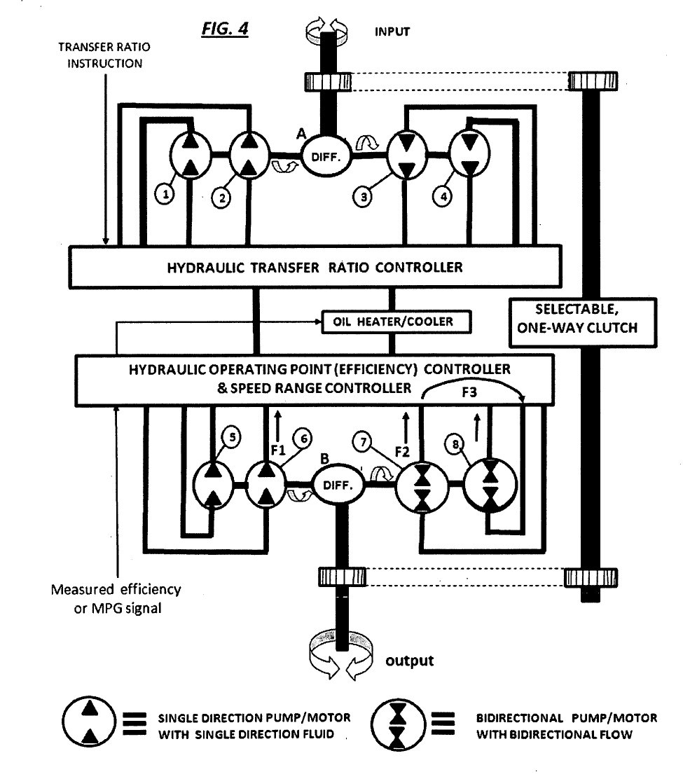

FIG. 4 illustrates the addition of an all mechanical by-pass implemented with a selectable, one-way clutch. This is intended to produce a higher efficiency when used in a vehicle for extended periods at high speeds or under low torque conditions at low speeds. An important feature of the one-way clutch is to allow the transmission to return to hydraulic operation from all mechanical operation merely by causing the vehicle to decelerate. In essence the vehicle is operating in “free-wheeling” mode in “overdrive” when the mechanical by-pass is selected. In addition, coming out of “overdrive” can be achieved de-selecting the clutch and setting the hydraulic portion of the transmission to accelerate the vehicle. When used in a vehicle employing hydraulic regenerative braking it is desirable that the braking be applies as soon as the clutch is disengaged.

In this example we have shown the variable input pump as the means to control the transfer ratio and the output motors to control the operating point of the transmission. Also illustrated is the use of two motor/pumps in each position. By disabling one of the two motor/pumps in some or all of the positions, the operation of the transmission can be tailored more closely to any specific requirement. A further of two or more hydraulic devices on each side of the differential is to allow the transmission to operate at higher hydraulic pressures. This is accomplished by configuring each position such that the two devices operate in series rather than parallel. This increases the maximum allowable system pressure by approximately a factor of two, which will be important when higher pressure accumulators are available. This configuration also allows a change in speed range since for the same flow rate, the shaft rotational speed will double if both motors are arrange in series rather than in parallel. Flow F3 illustrates the two motors being operated in series rather than in parallel. As taught in the Goldenberg publication, the output speed can also be doubled by causing both “arms” of the output Goldenberg set to drive the output shaft in the same direction. This however will result in either the loss of transfer ratio control or efficiency control.

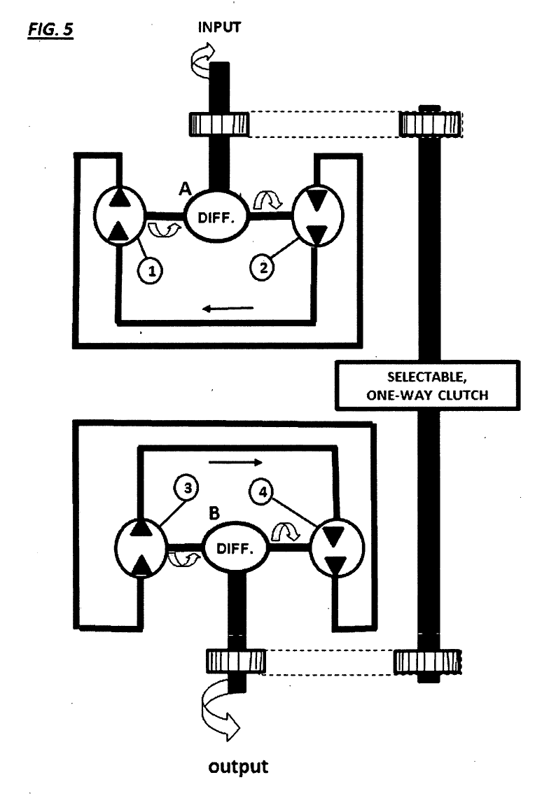

When the mechanical by-pass is selected, it is desirable to have minimum hydraulic losses in the transmission since the hydraulic transmission is in idle mode and not serving any function. FIG. 5 illustrates a flow arrangement that provides for minimum power losses. It accomplishes this by the following means:
A. Since there is a complete separation of the hydraulic input from the hydraulic output, there is no chance for energy consuming interference between the two.
B. This configuration results in the lowest possible rotational speed of the devices for any input and output speed therefore the lowest mechanical losses.
C. This configuration results in the lowest volume of fluid that needs to be re-circulated; therefore the lowest fluid friction losses.
D. Since the driven devices are on the opposite sides of the differential, they each can rotate at a different speed without interference. If the displacement or efficiency of one is different from the other, they are able to rotate at different speed for the same fluid flow rate.
E. Since both devices are pumping the same fluid, the energy required to accelerate and decelerate the fluid is minimized.
   This low loss condition in “hydraulic standby” obviates the need for multiple ‘slippage’ clutches to disengage the hydraulic inputs and outputs when the vehicle is driven by all-mechanical path.

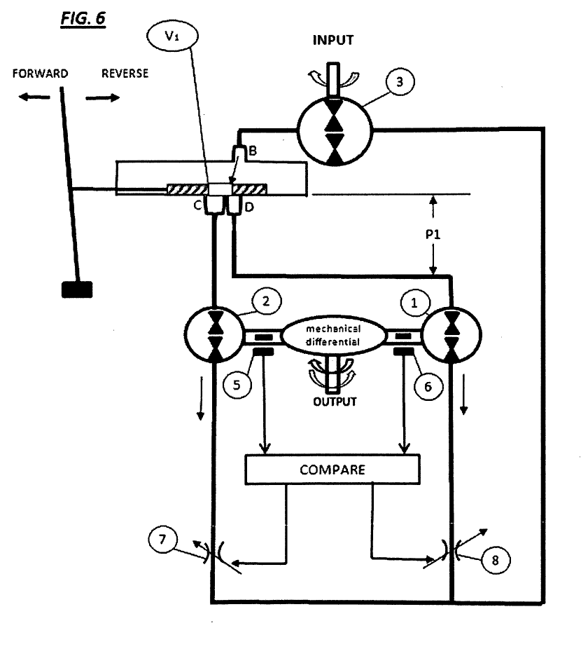

If the gearing of the two arms of a mechanical differential are the same, it is a characteristic of the differential that the torque will be the same in both arms when the third arm is under a load. The torque in the arms of motors 1 and 2 in FIG. 6 is proportional to the pressure across each motor, times the displacement of each, times the efficiency of each. If we start with the zero output speed condition, the displacement, efficiency and applied pressure will be close so the system most likely would be stable (Partly because there is no load on the output because it isn't turning). However, as we divert some flow from motor 1 to motor 2 (the case illustrated in FIG. 6), a pressure drop P1 develops across the constriction produced by valve V1. This will reduced the applied pressure to motor 1, thereby reducing the torque it produces. (However as it slows down, it will in many cases experience an increase in efficiency (per FIG. 2) possible compensating for the loss in applied pressure. Further as motor 2 speeds up, in all likelihood reducing its efficiency (see FIG. 2) and therefore the torque it produces (also compensating or over compensating for the loss in torque due to pressure drop P1)). If the torque becomes unbalanced, the unit with the highest torque will tend to “overcome” the other unit and drive it in the opposite direction, with the result of little or no torque applied to the output. To prevent this case, it is necessary to make sure the torques are equal under all conditions. This invention teaches the use of control signal proportional to the magnitude and sign of the difference in torque between the two sides and using this signal to change the pressure (in a minimum power loss manner) of the appropriate device to accomplish the equalization to the torques.

One way to accomplish this is to measure the torque directly on each shaft of motors 1 & 2 thru the use of wireless strain gauges 5 & 6. Then to subtract the torque reading from motor 1 from the torque reading of motor 2. If the resulting signal is negative it means the torque in motor 1 is greater than motor 2. To correct this situation, a small constriction is introduced in the hydraulic line from motor 1. This will reduce slightly the applied pressure on motor 1 to the degree necessary to make the torques equal from both motors, thus assuring stable situation under any load and speed condition. Since in most cases there is a natural tendency for the efficiency in both devices to change in the direction that favors stability, only small flow restrictions need be introduced to achieve stability and this will usually be on the device that is handling the lowest power. Therefore the overall loss in system efficiency will be small using this technique.

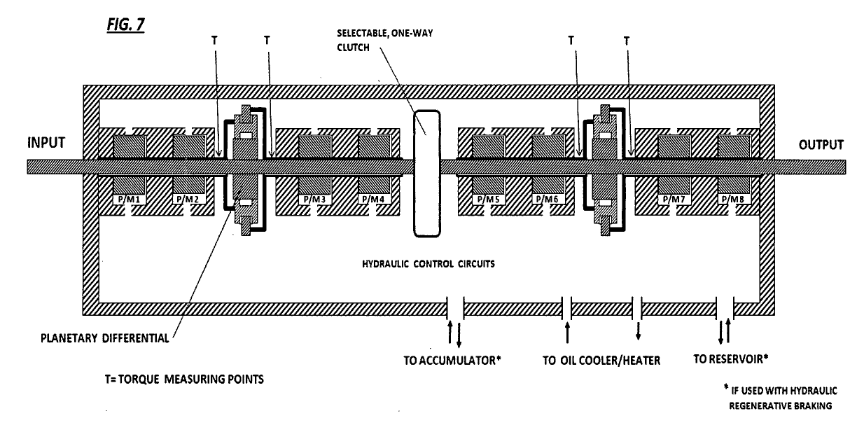

FIG. 7 illustrates one of many possible mechanical layouts of the transmission showing the packaging and size benefits from using planetary gears to perform the differential function. This particular configuration results in the smallest physical size, the most efficient mechanical by-pass system possible and the lowest material and manufacturing costs.

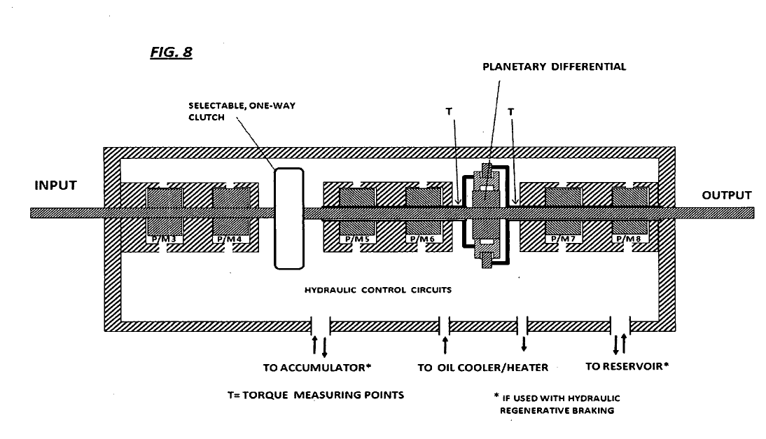

FIG. 8 describes a mechanical design for the Goldenberg transmission with the addition of the stabilizing arrangement and with an all mechanical by-pass. To avoid the low efficiency points in this transmission, it is desirable to use the total vehicle mpg to set the engine speed in conjunction with the transmission transfer ratio. The concentric design results in minimum size.

The selectable, one-way clutch means to select an all-mechanical by-pass can be advantageously applied to any hydro-mechanical transmission.

While the invention has been described in conjunction with a specific exemplary and preferred modes, it is to be understood that many alternatives, modifications and variations, are possible. Similarly, the respective elements described for effecting the desired functionality can be configured differently, per constraints imposed by different mechanical systems, yet perform substantially the same function, in substantially the same way to achieve substantially the same result as the above

I claim:

1. A hydro-mechanical transmission system comprising in combination;
a) a first mechanically driven, input set of Goldenberg differentially-coupled fixed displacement hydraulic pumps/motors providing a hydraulic fluid output;
b) a diverter control valve means receiving the hydraulic fluid output from the input set of Goldenberg differentially-coupled fixed displacement hydraulic pumps/motors, the diverter control valve means of apportioning hydraulic fluid flow respectively between the hydraulic pumps/motors on one side of the differential with the pumps/motors on the other side;
c) a second, hydraulically driven, output set of Goldenberg differentially-coupled fixed displacement hydraulic pumps/motors mechanically rotating an output shaft receiving hydraulic fluid from, and apportioned by a second diverter control valve means for controlling the direction and rotational velocity of the output shaft; wherein the first mechanically driven, input set of Goldenberg differentially-coupled fixed displacement hydraulic pumps/motors and first diverter control valve means afford operating point control for optimizing efficiency or changing the transfer ratio of the transmission system, and the second, hydraulically driven, output set of Goldenberg differentially-coupled fixed displacement hydraulic pumps/motors and second diverter control valve means afford control over mechanical output from the transmission system or the operating point of the system for efficiency control.

2. The transmission system of claim 1, wherein additional control over the efficiency of transmission is accomplished by providing a means for adjusting the temperature/viscosity of the hydraulic fluid.

3. The transmission system of claim 1, and further including:
a. means for sensing mechanical torque on each side of each mechanical differential, and producing a sensed electronic signal proportional to the torque experienced by the respective sides of each of the respective differentials; and
b. means for comparing the respective sensed electronic signals from each particular mechanical differential and providing a difference signal indicative of magnitude and polarity of any difference between the respective sensed electronic signals from each side of the differential; and
c. means for adjusting hydraulic fluid pressure applied in each hydraulic device on each side of the mechanical differentials in response to said difference signal in such a manner as to cause the torque to be the same on both sides of the respective mechanical differentials.

4. The transmission system of claim 3, wherein:
a. the torque experienced by each side of each differential is sensed directly by a wireless connection to strain gauges integrated with each shaft on each side of each of the respective mechanical differentials.

5. The transmission system of claim 3, wherein:
a. the pressure applied to the hydraulic devices on each side of the differential is adjusted by an adjustable flow mechanism located for constricting flow of the hydraulic fluid in each output flow leg of each hydraulic device independent of the position of the position of the diverter valve of claim 1.

6. The transmission system of claim 1, wherein:
a. each side of each set of Goldenberg differentially-coupled fixed displacement hydraulic pumps/motors includes at least two hydraulic pumps/motors; and
b. means for controllably directing hydraulic fluid flow serially through at least one pump/motor device and then flows through one more subsequent pump/motor devices coupled for rotatably driving a common shaft in the same direction for allowing the pressure applied to the assemble to exceed the pressure rating of the individual hydraulic pump/motors devices.

7. The transmission system of claim 1, wherein:
a. each side of each set of Goldenberg differentially-coupled fixed displacement hydraulic pumps/motors includes at least two hydraulic pumps/motors; and
b. means for disabling one or more hydraulic pump/motors on each side of the differentials to change the power capacity of the transmission.

8. The transmission system of claim 1, and further including:
a. The use of different displacement hydraulic devices on one side of a Goldenberg differentially-coupled fixed displacement hydraulic pump/motors as compared to the other side; and
b. The use of different mechanical gearing on each side of the differential so that the torque can be made equal on both sides thereby allowing a different output or input speed range in one rotational direction from the speed range in the other opposite rotational direction.

9. The transmission system of claim 1, and further including:
a. an all-mechanical by-pass of the hydraulic portion of the transmission;
b. a means by the use of a selectable, one-way clutch to engage and disengage the all mechanical by-pass;

10. The transmission system of claim 9, and further including:
means for circulating hydraulic fluid within the transmission system when the system is decoupled from the drive train, respectively, and independently, serially through the hydraulic pump/motor devices on one side of each particular set of Goldenberg differentially-coupled fixed displacement hydraulic pumps/motors and then through the hydraulic pump/motor devices on the other side of that particular set of Goldenberg differentially-coupled fixed displacement hydraulic pumps/motors, such that the rotational speed of the pump/motor devices on each side of the respective sets can be different from each other to accommodate differences in displacement and efficiency.

11. The transmission system of claim 9, and further including:
a means to de-select the selectable, one-way clutch under the condition that the control signal is calling for acceleration above a predetermined level or by use of a “shift-down” signal, and thus allowing hydraulic portion of the transmission to “take over” and in effect accomplishing a feature commonly found in a vehicle with “overdrive” wherein the transmission shifts down out of overdrive when considerable additional acceleration is called for by the vehicle operator.

12. The transmission of claim 9, designed in such a manner that:
a. a planetary differential gear set is mounted in the approximate middle of a round shaft designated as the input shaft of the transmission and the sun gear of the differential being concentric with the input shaft and connected to it; and
b. one or more hydraulic pumps/motors on tubular shafts mounted concentric with the input shaft one each on each side of the differential with one tubular shaft connected to the planet gears of the differential and the other connected to the sun gear of the differential with sufficient space between the planetary differential and the pump/motors on both sides to allow for the wireless strain gauges; and
c. one end of the input shaft extending beyond the said tubular shafts to allow a mechanical input connection on one end and a connection to a selectable, one-way clutch mounted concentric with and on the other end of the input shaft; and
d. an output shaft attached concentric with the other side of the selectable, one-way clutch with a planetary differential and hydraulic devices mounted on the tubular shafts in the same manner as those mounted on the input shaft and a sufficient extension of the output shaft beyond the tubular shaft at the end opposite to the clutch, to allow the output shaft to serve as a mechanical output for the transmission.

13. A hydro-mechanical transmission system comprising in combination;
a. a set of Goldenberg differentially-coupled fixed displacement hydraulic pumps/motors providing either a hydraulic fluid output or functioning as hydraulic motor;
b. a diverter control valve to apportion the fluid flow between said differentially coupled hydraulic pumps/motors;
c. a fixed or variable displacement hydraulic device serving either as an input or output pump/motor;
d) a means to measure either directly or indirectly the shaft torque between differential and the pumps/motors of the Goldenberg differentially-coupled fixed displacement set; and
e) a means to independently adjust the pressure across the pumps/motors on each side of the differential is a manner as to cause the torque on both sides of the differential to be equal.

14. The transmission system of claim 13, wherein:
the torque experienced by each side of each differential is sensed directly by a wireless connection to strain gauges integrated with each shaft on each side of the mechanical differential

15. The transmission system of claim 13, wherein additional control over the efficiency of transmission is accomplished by providing a means for adjusting the temperature/viscosity of the hydraulic fluid.

16. The transmission system of claim 13, wherein:
the pressure applied to the hydraulic devices on each side of the differential is adjusted by an adjustable flow mechanism located for constricting flow of the hydraulic fluid in each output flow leg of each hydraulic device independent of the position of the diverter valve of claim 13.

17. The transmission system of claim 13, wherein:
a. each side the of Goldenberg differentially-coupled fixed displacement hydraulic pumps/motors includes at least two hydraulic pumps/motors; and
b. means for controllably directing hydraulic fluid flow serially through at least one pump/motor device and then flows through one more subsequent pump/motor devices coupled for rotatably driving a common shaft in the same direction allowing the pressure applied to the assemble to exceed the pressure rating of the individual hydraulic pump/motors devices.

18. The transmission system of claim 13, further including:
a. The use of different displacement hydraulic devices on one side of a Goldenberg differentially-coupled fixed displacement hydraulic pump/motors as compared to the other side; and
b. The use of different mechanical gearing on each side of the differential so that the torque can be made equal on both sides thereby allowing a different speed range in one rotational direction from the speed range in the other opposite rotational direction.

19. The transmission system of claim 13, further including:
a. an all-mechanical by-pass of the hydraulic portion of the transmission;
b. a means by the use of a selectable, one-way clutch to engage and disengage the all-mechanical by-pass;

20. The transmission system of claim 19, further including:
means for circulating hydraulic fluid within the transmission system when the system is decoupled from the drive train serially through the hydraulic pump/motor devices on one side of the Goldenberg differentially-coupled fixed displacement hydraulic pumps/motors and then through the hydraulic pump/motor devices on the other side of the Goldenberg differentially coupled fixed displacement hydraulic pumps/motors, such that the rotational speed of the pump/motor devices on each side of the respective sets can be different from each other to accommodate differences in displacement and efficiency.

21. The transmission system of claim 19, and further including:
a means to de-select the selectable, one-way clutch under the condition that the control signal is calling for acceleration above a predetermined level or by use of a “shift-down” signal, and thus allowing hydraulic portion of the transmission to “take over” and in effect accomplishing a feature commonly found in a vehicle with “overdrive” wherein the transmission shifts down out of overdrive when considerable additional acceleration is called for by the vehicle operator.

22. The transmission system of claim 13, wherein both the engine speed and the transfer ration of the transmission are controlled using the overall miles per gallon of the vehicle such that the operating points of the transmission exhibiting low efficiency can be avoided.

23. The transmission of claim 19, designed in such a manner that:
a. a planetary differential gear set is mounted in the approximate middle of a round shaft also serving as either the input or output shaft of the transmission; and the sun gear of the planetary differential being concentric with the shaft and connected to it; and
b. one or more hydraulic pumps/motors on tubular shafts mounted concentric with said shaft one each on each side of the differential with one tubular shaft connected to the planet gears of the planetary differential and the other connected to the sun gear of the planetary differential with sufficient space between the planetary differential and the hydraulic devices, on both sides to allow for the wireless strain gauges; and
c. one end of the shaft extending beyond the said tubular shafts to allow an input or output connection on one end and a connection to a selectable, one-way clutch mounted concentric with the other end of the shaft; and
d. a second shaft attached concentric with the other side of the selectable, one-way clutch with one or more fixed or variable displacement hydraulic devices mounted concentric with the shaft with sufficient shaft length extending beyond the hydraulic devices to allow the shaft to serve either as an input or output shaft of the transmission.

24. A hydro-mechanical transmission system comprising in combination;
a, hydraulic pumps and motors, of either fixed or variable displacements; and
b, an all-mechanical means to bypass the hydraulic portion of the transmission; and
c. a selectable, one-way clutch as a means to enable or disenable the all-mechanical means to by-pass the hydraulic transmission.
